(19) United States
(12) Patent Application Publication
(10) Pub. No.: US 2009/0117324 A1
(43) Pub. Date: May 7, 2009

(54) ELECTRONIC SUBSTRATE HAVING CAVITIES AND METHOD OF MAKING

(76) Inventors: Seong Choon Lim, Penang (MY); Eit Thian Yap, Penang (MY); Wei Liam Loo, Penang (MY)

Correspondence Address: Kathy Manke;Avago Technologies Limited, 4380 Ziegler Road, Fort Collins, CO, 80525, US

(21) Appl. No.: 11/935,126

(22) Filed: Nov. 5, 2007

(51) Int. Cl. B32B 3/26; B32B 37/26

(52) U.S. Cl. 428/138; 156/256; 428/188

(57) ABSTRACT

Electronic substrates having cavities located therein and methods of making the substrates are disclosed herein. An embodiment of a method of making the substrate comprises manufacturing a circuit board. An adhesive film is attached to the circuit board, wherein the adhesive film has a first side facing the circuit board and a second side located opposite the first side, and wherein the second side is adhesive. At least one cavity is formed in a material. The material is adhered to the second side of the adhesive film.

### BACKGROUND

Cavities on electronic substrates are required for many applications. The cavities are typically required to be drilled, into the substrate, but not all the way through. Electronic connections, such as conductive pads may be located within the cavities. As electronic substrates become smaller, the precision required in the drilling operation increases substantially, which causes the drilling operation to become very expensive. In addition, locating the pads within the drilled cavities becomes more difficult as the substrates become smaller.

### BRIEF DESCRIPTION OF THE DRAWINGS

FIG. 1 is a side cut away view of an embodiment of an electronic substrate.

FIG. 2 is a top perspective view of the electronic substrate of FIG. 1.

### DETAILED DESCRIPTION

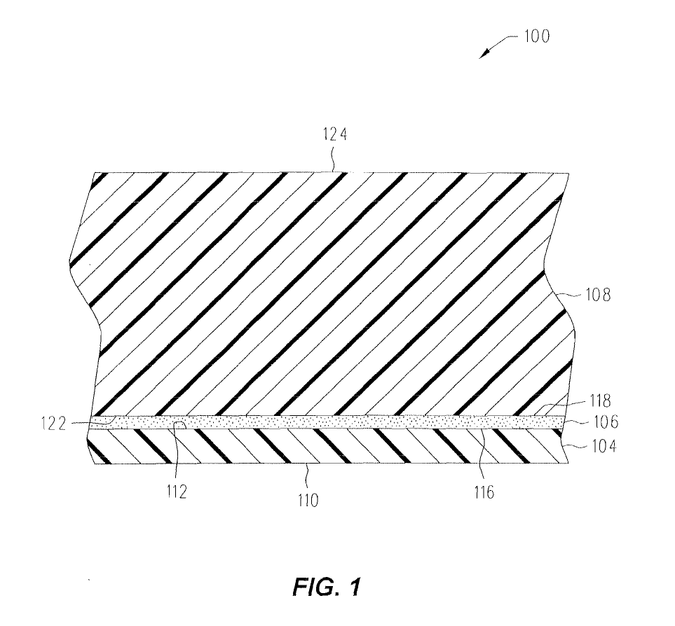

Electronic substrates and methods of making electronic substrates having cavities formed thereon are disclosed herein. FIG. 1 is a side cut away view of an embodiment of an electronic substrate 100. The embodiment of the substrate 100 includes a circuit board 104, an adhesive film 106, and a material 108. As described in greater detail below, the adhesive film 106 is located between the circuit board 104 and the material 108. The circuit board 104, the adhesive film 106, and the material 108 may all be laminated together.

The circuit board 104 may be a rigid-type or flexible-type circuit board. The circuit board 104 has a first side 110 and a second side 112 located opposite the first side 110. The sides 110, 112 are surfaces of the circuit board 104. The second side 112 of the circuit board 104 is located proximate the adhesive film 106. Electronic traces and the like (not shown in FIG. 1) may be located on or within the circuit board 104. For example, electronic traces may be located on the first side, second side 112, or both sides of the circuit board 104. The electronic traces serve to connect electronic components to the circuit board 104 and to transmit signals throughout the circuit board 104. Conductive pads also may be located on the second side 112 of the circuit board 104 and may serve to connect components to the circuit board 104 and to connect wires and the like to the circuit board 104.

The adhesive film 106 may he referred to as a bonding film or a lamination material. The adhesive film 106 has a first side 116 and a second side 118 located opposite the first side. The sides 116, 118 constitute surfaces of the adhesive film 106. The first side 116 of the adhesive film 106 is attached to the second side 112 of the circuit board 104. In some embodiments, the first side 116 of the adhesive film 106 comprises an adhesive and the first side 116 of the adhesive film 106 is adhered to the second side 112 of the circuit board 104. In some embodiments, an adhesive may be applied to the second side 112 of the circuit board 104 or the first side 116 of the adhesive film 106 and the adhesive film 106 may be subsequently adhered to the second side 112 of the circuit board 104.

As described in greater detail below, the adhesive film 106 may have portions cut out so that the adhesive film 106 does not cover any pads or other contacts located on the second side 112 of the circuit board 104 that require electrical connections. In other embodiments, the adhesive film 106 may be applied to the second side 112 of the circuit board 104 as a continuous sheet. Portions of the adhesive film 106 may be cut out of the continuous sheet in order to enable electrical connections to be made to pads or other contact points on the circuit board 104.

The material 108 may comprise pre-molded or pre-cut (include drilled), Polyethylene (PET), polyphthalamide, liquid crystal polymer, FR-4 or other materials. In some embodiments, the material 108 is rigid and may be more rigid than the circuit board 104. In some embodiments, the material 108 may be able to withstand high temperature, such as the temperature required to bond or solder components to the circuit board 104.

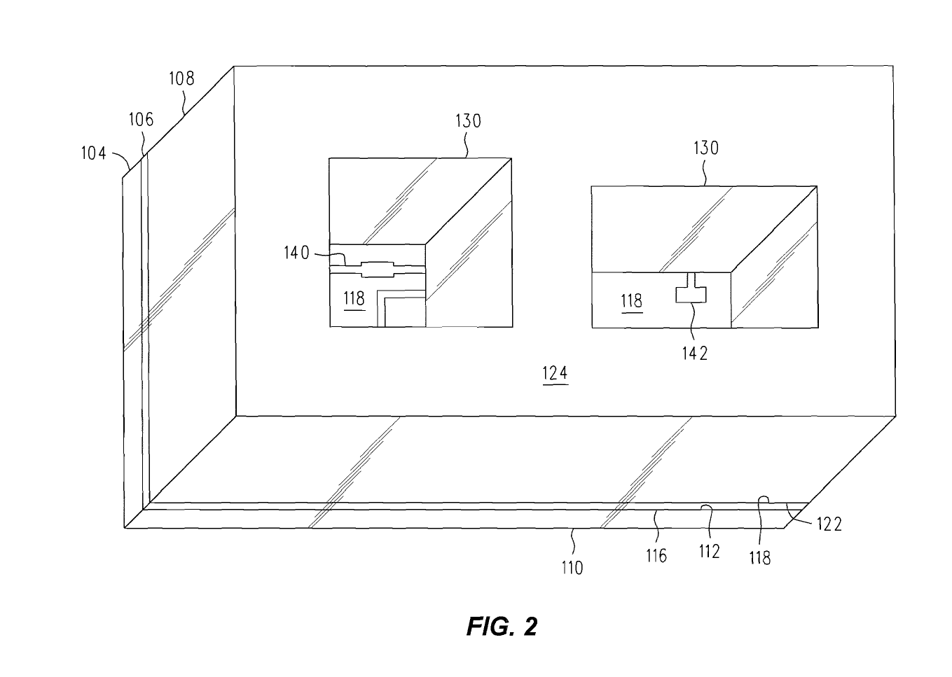

The material 108 has a first side 122 and a second side 124 located opposite the first side 122. The sides 122, 124 are surfaces of the material 108. The first side 122 of the material 108 is adhered to the second side 118 of the adhesive film. With additional reference to FIG. 2, which is a top perspective view of the substrate 100, the material has cavities 130 formed therein. In the embodiment described herein, the cavities 130 extend between the first side 122 and the second side 124. The cavities 130 may be virtually any shape and may be formed by drilling, die-set punch, or other methods. When the material 108 is adhered to the adhesive film 106, the cavities 132 become part of the substrate 100. The height of the substrate from the first side 110 of the circuit board 104 to the second side 124 of the material 108 may be approximately 0.6 millimeters.

The embodiment of the substrate 100 of FIG. 2 shows traces 140 and pads 142 as described above. The traces 140 serve to conduct electricity throughout the circuit board 104. The pads 142 serve as connection points for wires or components that are connected to the circuit board 104. The adhesive film 106 may be cut to substantially the same shape or pattern as a side 122, 124 of the material. Thus, there will not be any adhesive film 106 adhered to the second side 112 of the circuit board 104 that would interfere with the electrical connections between the pads 142 and components or wires connected thereto.

An embodiment of manufacturing the substrate 100 includes manufacturing the circuit board 104. The adhesive film 106 is then applied to the second side 112 of the circuit board 104. As stated above, the adhesive film may have portions cut out so as not to interfere with traces 140, pads 142, and other conductive points and components located on the second side 112 of the circuit board 104. In other embodiments, the adhesive film 106 maybe a continuous sheet.

The material 108 is manufactured to have the cavities 130 located therein. The cavities 130 may extend between the first surface 122 and the second surface 124 of the material 108. As stated above, the cavities 130 may be drilled or preformed, such as being molded with the material. 108. The material 108 may also be die set punched. The cavities 130 may be located in areas where contacts or components are located on the second surface 112 of the circuit board 104. The material 108 is adhered to the second side 118 of the adhesive film 106. Thus, the substrate now exists with cavities 130 located thereon. In embodiments where the adhesive film 106 is a continuous sheet, portions of the adhesive film 106 located proximate the cavities 130 may be removed. Removal may be accomplished via mechanical or chemical processes. In some embodiments, the circuit board 104, the adhesive film 106, and the material 108 are laminated together.

What is claimed is:

1. A method of manufacturing a cavity on an electronic substrate, said method comprising:
manufacturing a circuit board;
attaching an adhesive firm to said circuit board, wherein said adhesive film has a first side facing said circuit board and a second side located opposite said first side, said second side being adhesive;
forming at least one cavity in a material; and
adhering said material to said second side of said adhesive film.

2. The method of claim 1, and further comprising laminating said circuit board, said adhesive film, and said material together.

3. The method of claim 1, wherein said circuit board is a flexible circuit board.

4. The method of claim 1, wherein said first side of said adhesive film is adhesive, and wherein said attaching comprises adhering said first side of said adhesive film to said circuit board.

5. The method of claim 1, wherein said material comprises polyphthalamide.

6. The method of claim 1, wherein said material comprises liquid crystal polymer.

7. The method of claim 1, wherein said material comprises FR-4.

8. The method of claim 1, wherein said forming at least one cavity comprises forming at least one through hole.

9. The method of claim 1, wherein said forming at least one cavity comprises drilling at least one cavity.

10. The method of claim 1, wherein said forming at least one cavity comprises die-set punching at least one cavity.

11. The method of claim 1, wherein said forming at least one cavity comprises pre-molding said at least one cavity.

12. The method of claim 1, wherein said circuit board has at least one electrical trace located thereon, wherein said cavity is a through hole, and wherein at least a portion of said at least one electrical trace is located in said cavity.

13. An electronic substrate comprising:
a circuit board;
an adhesive film attached to said circuit board, wherein said adhesive film has a first side facing said circuit board and a second side located opposite said first side, said second side being adhesive; and
a material with at least one cavity formed therein, wherein said material is adhered to said second side of said adhesive film.

14. The electronic substrate of claim 13, wherein said circuit board, said adhesive film, and said piece of material are laminated together.

15. The electronic substrate of claim 13, wherein said circuit board is a flexible circuit board.

16. The electronic substrate of claim 13, wherein said first side of said adhesive film is adhesive, and wherein said first side of said adhesive film is adhered to said circuit board.

17. The electronic substrate of claim 13, wherein said material comprises polyphthalamide.

18. The electronic substrate of claim 13, wherein said material comprises liquid crystal polymer.

19. The electronic substrate of claim 13, wherein said material comprises FR-4.

20. The electronic substrate of claim 13, wherein said at least one cavity comprises at least one through hole.

21. The electronic substrate of claim 13, wherein said at least one cavity comprises a die-set punched hole.

22. The electronic substrate of claim 13, wherein said material comprises Polyethylene (PET).
